(19) United States
(12) Patent Application Publication
(10) Pub. No.: US 2017/0256177 A1
(43) Pub. Date: Sep. 7, 2017

(54) GENEALOGY AND HEREDITARY BASED ANALYTICS AND DELIVERY

(71) Applicant: International Business Machines Corporation, Armonk, NY (US)

(72) Inventors: Faried Abrahams, Laytonsville, MD (US); Amol A. Dhondse, Pune (IN); Kerrie L. Holley, Montara, CA (US); Anand Pikle, Pune (IN); Gandhi Sivakumar, Bentleigh (AU)

(21) Appl. No.: 15/057,227

(22) Filed: Mar. 1, 2016

(51) Int. Cl. G09B 19/00; G06F 19/00

(52) U.S. Cl. CPC G09B 19/0046; G06F 19/322

(57) ABSTRACT

A method and system for making recommendations based on analyzed hereditary and genetic data is provided. The method includes receiving data associated with a family origin and identifying a set of characteristics from the data, which are associated with an individual within a family tree. The method further includes creating an object pattern from the set of characteristics, to define a scoring model, and providing a recommendation using an electronic device to members of a family based on the created object patterns.

### BACKGROUND OF THE INVENTION

The present invention relates generally to the field of analyzing data, and more particularly to the analytics and delivery of information based on the genealogy and heredity of an individual.

Individuals may have a desire to know their family origins, and the characteristics associated with each family member of their family tree. Further, an individual may want to pass down certain intellectual learning, tips, and techniques to future generations of family members.

Genealogical record keeping has traditionally involved isolated efforts to assemble and maintain stores of information, and different cultures have created unique methods for maintaining genealogical records. Currently, methods for combining genetic and genealogical information are known, in order to enable an identification of ancestral relations across earlier generations to a degree that is more accurate than written records or from using an individual's memory. Many of these written records, storing information including records of births, deaths, marriages, and/or military involvement, are currently accessible on various electronic media, such as the Internet.

As the population grows, it is often not feasible for an individual to keep track of the history of each family member across multiple earlier generations, including physical and genetic characteristics and personal preferences (e.g., favorite music) associated with those family members, in order for the individual to make prompt, informed decisions, such as medical-related decisions or social decisions. There is a need for automatically analyzing the genealogy and heredity of an individual, and providing an instantaneous, up-to-date recommendation or advice to the individual, based on their analyzed genetic and hereditary history.

### SUMMARY

According to an embodiment of the present invention, a method for making individualized recommendations is provided. The method comprises: receiving a plurality of genetic and hereditary data associated with a family origin and identifying a set of characteristics associated with an individual, from the plurality of genetic and hereditary data, in a tree. The method further comprises creating an object pattern used to define a scoring model, based on the set of characteristics, and providing a recommendation to one or more members of a family using an electronic device, where the recommendation is based on the individual and object patterns associated with the set of characteristics.

Another embodiment of the present invention provides a computer program product for making individualized recommendations, based on the method described above.

Another embodiment of the present invention provides a computer system for making individualized recommendations, based on the method described above.

This may have the advantage that an individual can receive an instantaneous and accurate recommendation, based on a request. As the data used to calculate an object pattern and make the recommendation is constantly being updated, an individual is provided with a recommendation using up-to-date and comprehensive gathered data. Embodiments of the present invention may further have the advantage that an individual can receive a recommendation, based on data gathered beyond genetic data, but also encompassing personal preferences of earlier generations (e.g., preferred music genres), physical strengths and weaknesses, as well as personal tips or techniques (e.g., home remedies or recipes). Embodiments of the present invention may further have the advantage that an individual can engage with various family members across multiple earlier generations, by leveraging existing technologies, such as voice and video synthesizers, to re-create the sound and appearance of certain family members.

### BRIEF DESCRIPTION OF THE DRAWINGS

FIG. 1 depicts a functional block diagram of a genetics analysis environment, in accordance with an embodiment of the present invention;

FIG. 2 depicts a diagram of an example family tree, in accordance with an embodiment of the present invention;

FIG. 3 depicts a flowchart illustrating operational steps of a analytics controller program for making recommendations based on analyzed hereditary and genetic data, in accordance with an embodiment of the present invention; and

FIG. 4 depicts a block diagram of components of a computing device, in accordance with an illustrative embodiment of the present invention.

### DETAILED DESCRIPTION

Embodiments of the present invention provide systems and methods for gathering data from various disparate sources, in real-time, and analyzing the gathered data to create an object pattern using a scoring model for the gathered data. Embodiments of the present invention provide systems and methods for providing a real-time recommendation to an individual, based on the data gathered from multiple input modes about the genetic and hereditary information of that individual. As the amount of data pertaining to the family members of an individual grows over time, it may be difficult for an individual to keep track of the history of each family member across multiple earlier generations, including physical and genetic characteristics and personal preferences (e.g., favorite music) associated with those family members.

Embodiments of the present invention may have the advantage that an individual's characteristics, including hereditary and genetic information, can be obtained from various sources over time, organized into a personal family tree, and analyzed to define a scoring model based on the various gathered characteristics. Embodiments of the present invention can gather the hereditary and genetic information from various disparate resources, as well as leverage existing, embedded electronic device technologies, such as embedded sensors and video and voice capture technologies, to gather physiological data about the individual, and additionally, leverage the computing capacity of the electronic device on which the invention is operating. Embodiments of the present invention can blend the gathered physiological characteristics of an individual along with reference data, such as geo-location, time of day, and weather information, to calculate a score using the scoring model, and make a recommendation based on the calculated scoring model.

Embodiments of the present invention may additionally have the advantage that such information beyond genetics, such as tips, techniques, and intellectual learning, can be passed down through generations. Embodiments of the present invention allow an individual to engage with family members across multiple generations in a personalized manner (e.g., a holograph or a voice synthesizer). Each family member can receive personalized advice through an electronic device (e.g., a mobile electronic device), based on the gathered hereditary and genetic information.

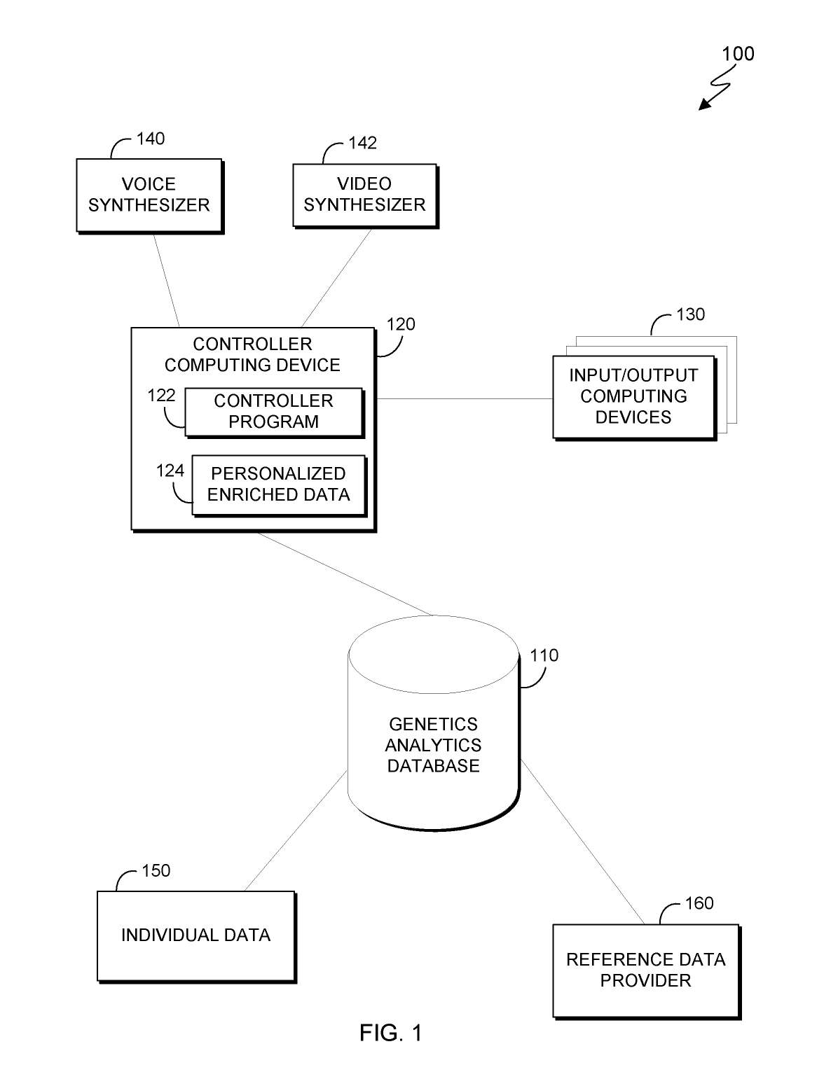

The present invention will now be described in detail with reference to the Figures. FIG. 1 depicts a functional block diagram illustrating a genetics analysis environment, generally designated 100, in accordance with an embodiment of the present invention. Modifications to genetics analysis environment 100 may be made by those skilled in the art without departing from the scope of the invention as recited by the claims. In an exemplary embodiment, genetics analysis environment 100 includes genetics analytics database 110, controller computing device 120, input/output (I/O) computing devices 130, voice synthesizer 140, video synthesizer 142, individual data 150, and reference data provider 160.

Genetics analytics database 110 is an information repository, storing family characteristics from reference data provider 160, individual data 150, and other sources of family characteristics. Information from genetics analytics database 110 can be accessed by controller computing device 120. Genetics analytics database 110 can capture physiological data using multiple input modes (e.g., mobile devices, wearable devices, smart textiles) and can build a hereditary and genetic data repository, which is used by controller program 122 to make personalized recommendations to individual family members, based on the captured data. In other embodiments, genetics analytics database 110 is integrated within controller computing device 120, and the gathered information is stored and accessed locally on controller computing device 120.

Individual data 150 is data obtained from many sources, for a particular individual. Individual data 150 may include data such as: physical characteristics of an individual changed over time (e.g., learning and motor skills), social network and/or friend networks of an individual, responses to events, family intellectual capital (e.g., medicines, cooking, arts, financial tips, business tips, and behavioral tips), physiological data obtained via wearable devices or smart textiles (e.g., body temperature, pulse rate, and activity rates), financial history (e.g., real estate, banks), medical history (e.g., range of major to minor medical events), and likes and dislikes of the individual changing over time.

Reference data provider 160 is at least one remote data provider, which provides reference information to genetics analytics database 110, in order to associate reference information with the other received data, such as individual data 150. Reference data provider 160 may provide reference data such as: geo-location data, time of day or year data, and weather data, among other reference data.

Controller computing device 120 includes controller program 122 and personalized enriched data 124. In various embodiments of the present invention, controller computing device 120 can be a laptop computer, a tablet computer, a netbook computer, a personal computer (PC), a desktop computer, a personal digital assistant (PDA), a smart phone, a thin client, a wearable device, or any programmable mobile electronic device capable of executing computer readable program instructions. Controller program 122 can receive data from genetics analytics database 110, and align the received data in order to create personalized enriched data 124. Personalized enriched data 124 is a local repository of data pertaining to each individual in a family, and is used in order to make a personalized recommendation to an individual. In some embodiments, each member of a family has an individual file or portion of storage within personalized enriched data 124, which includes the gathered data which is relevant to that family member, so that controller computing device 120 may calculate an individualized recommendation, depending on the individual requesting the recommendation. Controller program 122 can communicate with I/O computing devices 130, to provide a data output or to receive additional individual data.

I/O computing devices 130 can be a laptop computer, a tablet computer, a netbook computer, a personal computer (PC), a desktop computer, a personal digital assistant (PDA), a smart phone, a thin client, a wearable device, or any programmable mobile electronic device capable of executing computer readable program instructions. In some embodiments, I/O computing devices 130 are each associated with a different individual. I/O computing devices 130 can capture physiological data of an individual via multiple input modes, such as mobile, wearable, or smart textile devices, and can communicate the gathered information to controller program 122. I/O computing devices 130 can receive recommendations from controller program 122, based on the personalized data from personalized enriched data 124. In some embodiments, I/O computing devices 130 can be integrated with controller computing device 120, so that the physiological data of a user is captured, analyzed, and a recommendation is provided, from controller computing device 120.

Voice synthesizer 140 and video synthesizer 142 are dynamic, age-based voice and video capture and playback devices. In some embodiments, voice synthesizer 140 and video synthesizer 142 are integrated within, and can operate on, controller computing device 120. Voice synthesizer 140 can capture voice characteristics of individual family members, such as accents, tone of voice, resonance of voice, and other vocal characteristics. Voice synthesizer 140 can playback recommendations received from controller program 122, using the vocal characteristics of a certain family member. For example, voice synthesizer 140 may recite a family recipe, using the vocal characteristics of an individual's grandmother (e.g., playback using a soft-spoken, regional accent). Video synthesizer can include video and/or image capture technology, and can be used simultaneously with voice synthesizer 140 to playback a recommendation received from controller program 122, incorporating the voice characteristics of a certain family member into a video or image.

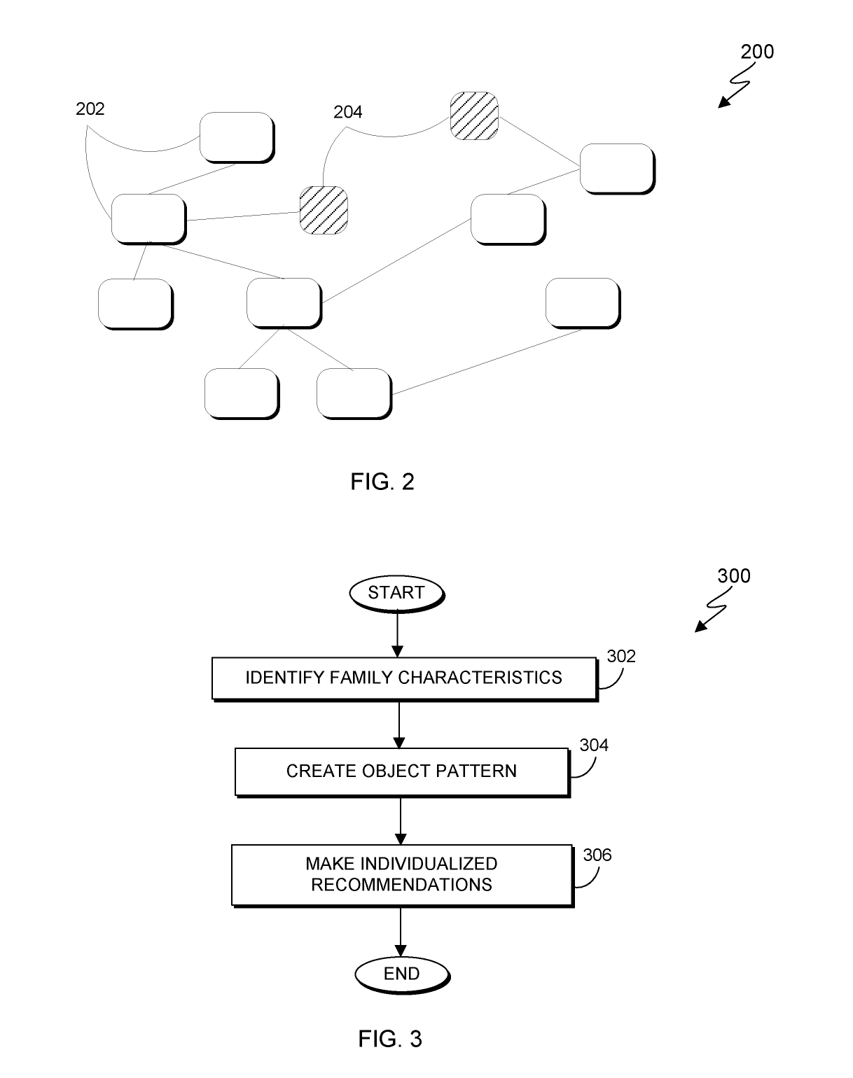

FIG. 2 depicts a diagram of an example family tree 200, in accordance with an embodiment of the present invention.

Individuals 202 are representative of family members, and are interconnected based on their familial relations to each other. Each individual 202 is associated with characteristics, such as voice, appearance, and learning skills, which have been obtained over time from mining hereditary and genetic data, as well as personal preferences and reference data. The characteristics of each individual 202 in family tree 200 are able to provide location-based prompts about each individual family member, via a personal family advisor for every individual of the family. In the case where data is unknown or insufficient, certain gaps in the family tree can be denoted, such as unknowns 204.

FIG. 3 depicts a flowchart illustrating operational steps of an analytics controller program for making recommendations based on analyzed hereditary and genetic data, in accordance with an embodiment of the present invention.

In step 302, controller program 122 identifies family characteristics. In this exemplary embodiment, individual family members are organized and associated with each other in a tree format (see FIG. 2). Each individual of the tree is then associated with a set of family characteristics, obtained from the genetic and hereditary data from the family origin. The family characteristics data may be obtained from I/O computing devices 130, individual data 150, reference data provider 160, and other forms of personal data capture devices. The family characteristics identified for each family member may include: voice, appearance, learning skills, individual preferences (e.g., favorite type of music, favorite game), financial assets, and medical histories.

In step 304, controller program 122 creates an object pattern. In this exemplary embodiment, an object pattern is created, based on the genealogy and hereditary family characteristics of the created family tree. The object pattern is used to define a scoring model, based on various characteristics, such as learning skills, motor skills, eating habits, disposition to certain medications, and other individual characteristics associated with, for example, physical appearance or aptitudes of an individual. In this exemplary embodiment, controller program 122 can continually receive updates and additional family characteristics information from various devices (e.g., I/O computing devices 130, individual data 150, reference data provider 160) and correlates the information into the object pattern scoring model of personalized enriched data 124, in order to provide more personalized recommendations to each individual family member.

In step 306, controller program 122 makes individualized recommendations. In this exemplary embodiment, controller program 122 uses the gathered family characteristics data from genetics analytics database 110, personalized enriched data 124, and reference data provider 160 data, in order to make an individualized recommendation to each member of a family (e.g., precautions to be taken with diet based on hereditary predicative analysis, preventative tests based on personal data or lifestyle data). In some embodiments, a recommendation can be made automatically (e.g., at a certain time of day, or in response to a certain triggering event) or can be made in response to a request from an individual. A device used by an individual can make individualized recommendations, based on a compilation of the received and scored data. For example, a user may select an output device, such as a mobile device, wearable device, or holograph-based personal assistant may be used to make an individualized recommendation, for each member of a family.

In some embodiments, a selected family member's preferences can be identified, upon request, in response to a user query using natural language. For example, the favorite music of an individual's great-grandfather can be automatically played back on a device, in response to a natural language query by the individual. In other embodiments, the object pattern scoring model can be used to help analyze and predict a medical issue. For example, the compilation of hereditary, genetic, and medical history data of a family can be used to more accurately predict a medical disorder of an individual family member, and to provide accurate medical direction to a health professional, based on the analyzed scoring model obtained across various categories (e.g., health, medical, food, and travel). In another embodiment, the object pattern scoring model may be used to provide personalized recommendations to individuals, based on physical strengths and weaknesses and/or motor skills in their family tree. For example, for an individual who has a family history of soccer players, controller program 122 may recommend that the individual try playing soccer or other similarly skilled sports. In yet another embodiment, controller program 122 can make recommendations to an individual family member, based on collected location data. For example, an individual may request information about a place that their great-grandfather visited in 1947. In another example, controller program 122 may provide a recommendation in an interactive manner, by incorporating characteristics of different family members. For example, in response to requesting a recommendation for a home remedy to a stomach ache, controller program 122 may playback a recommendation: i) as the first generation grandma of the requesting individual, where the recommendation is to chew betel leaves to alleviate the stomach ache; ii) as the grandpa of the individual, where the recommendation is to drink cumin seed water to alleviate the stomach ache; or iii) as the individual's mother, where the recommendation is to drink a carbonated beverage to alleviate the stomach ache. In this way, an individual can engage with, and receive recommendations from various family members across multiple generations. In this exemplary embodiment, controller program 122 continuously receives data updates from genetics analytics database 110, and is able to provide updated, real-time recommendations, based on the ongoing gathering and compilation of new family genetics data from various resources, as well as updated reference data and physiological data.

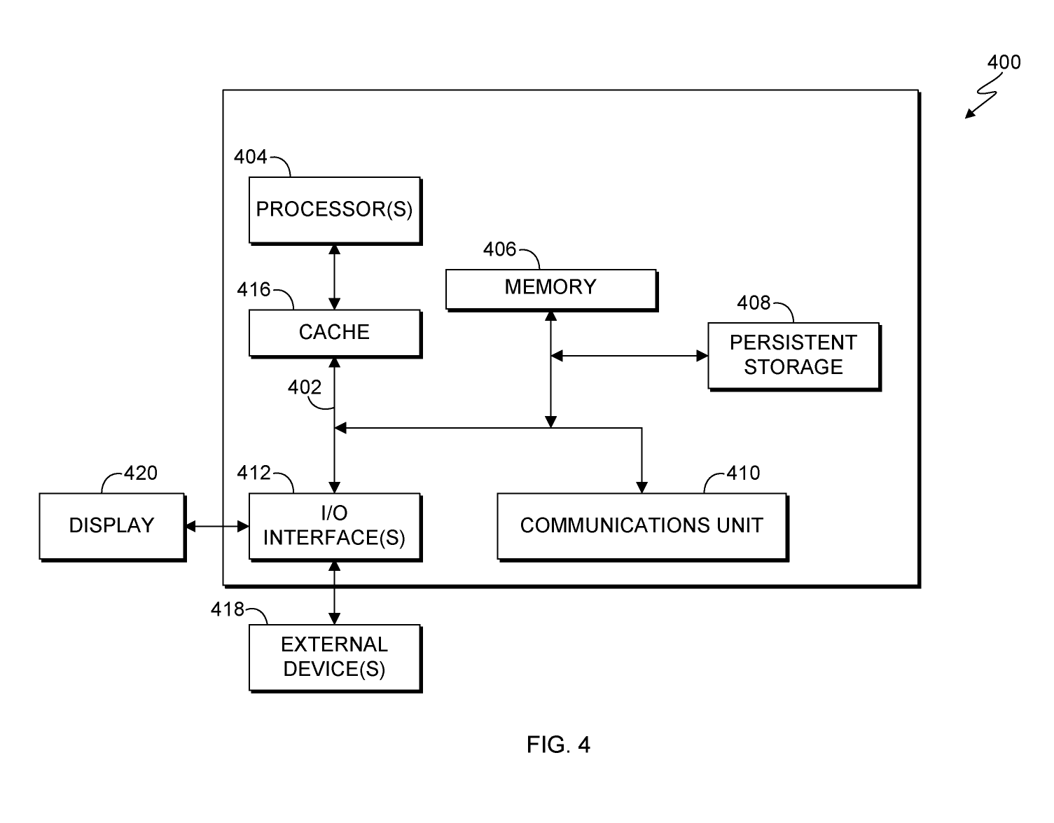

FIG. 4 depicts a block diagram of internal and external components of a computing device, generally designated 400, which is representative of components of FIG. 1, in accordance with an embodiment of the present invention. It should be appreciated that FIG. 4 provides only an illustration of one implementation and does not imply any limitations with regard to the environments in which different embodiments may be implemented. Many modifications to the depicted environment may be made.

Computing device 400 includes communications fabric 402, which provides communications between computer processor(s) 404, memory 406, cache 416, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM). In general, memory 406 can include any suitable volatile or non-volatile computer readable storage media. Cache 416 is a fast memory that enhances the performance of processors 404 by holding recently accessed data, and data near recently accessed data, from memory 406.

Program instructions and data used to practice embodiments of the present invention may be stored in persistent storage 408 and in memory 406 for execution by one or more of the respective processors 404 via cache 416. In an embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices, including resources of a network. In these examples, communications unit 410 includes one or more network interface cards. Communications unit 410 may provide communications through the use of either or both physical and wireless communications links. Program instructions and data used to practice embodiments of the present invention may be downloaded to persistent storage 408 through communications unit 410.

I/O interface(s) 412 allows for input and output of data with other devices that may be connected to computing device 400. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention (e.g., software and data) can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor, or a television screen.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method for making individualized recommendations, comprising:
receiving, by one or more processors, a plurality of genetic and hereditary data associated with a family origin;
identifying, by one or more processors, a set of characteristics associated with an individual, from the plurality of genetic and hereditary data, in a tree;
based on the set of characteristics associated with the individual, creating, by one or more processors, an object pattern used to define a scoring model; and
providing, by one or more processors, a recommendation to one or more members of a family, using an electronic device, wherein the recommendation is based on the individual and the object patterns associated with the set of characteristics.

2. The method of claim 1, further comprising:
receiving, by one or more processors, a plurality of reference data, wherein the plurality of reference data comprises geo-location data, time of day data, and weather data; and
associating, by one or more processors, the plurality of reference data with the received plurality of genetic and hereditary data.

3. The method of claim 1, wherein the plurality of genetic and hereditary data associated with a family origin is collected from at least two different input modes, and wherein the input modes comprise at least one of: a mobile device, a wearable device, a computing device, a tablet, and a smart textile.

4. The method of claim 1, wherein the set of characteristics comprise: physical characteristics of an individual changed over time, social networks of the individual, friend networks of the individual, responses to events, family intellectual capital, physiological data obtained via wearable devices or smart textiles, financial history, medical history, and personal preferences of the individual changing over time.

5. The method of claim 1, wherein providing a recommendation to one or more members of a family, further comprises at least one of:
providing the recommendation, using voice playback software in a simulated voice of an individual family member; and
providing the recommendation, using video playback software, which provides an image of the individual family member.

6. The method of claim 1, wherein a set of characteristics from the plurality of genetic and hereditary data comprises individual preferences for each family member.

7. The method of claim 1, wherein a recommendation comprises at least one of: precautions to be taken with diet based on hereditary predicative analysis; preventative tests based on personal data or lifestyle data; a set of preferences of an individual family member; medical direction associated with a medical history of a family member; dietary restrictions; travel recommendations based on location data; physical strengths; and physical weaknesses.

8. A computer program product for making individualized recommendations, comprising:
a computer readable storage medium and program instructions stored on the computer readable storage medium, the program instructions comprising:
program instructions to receive a plurality of genetic and hereditary data associated with a family origin;
program instructions to identify a set of characteristics associated with an individual, from the plurality of genetic and hereditary data, in a tree;
program instructions to, based on the set of characteristics associated with the individual, create an object pattern used to define a scoring model; and
program instructions to provide a recommendation to one or more members of a family, using an electronic device, wherein the recommendation is based on the individual and the object patterns associated with the set of characteristics.

9. The computer program product of claim 8, further comprising:
program instructions to receive a plurality of reference data, wherein the plurality of reference data comprises geo-location data, time of day data, and weather data; and
program instructions to associate the plurality of reference data with the received plurality of genetic and hereditary data.

10. The computer program product of claim 8, wherein the plurality of genetic and hereditary data associated with a family origin is collected from at least two different input modes, and wherein the input modes comprise at least one of: a mobile device, a wearable device, a computing device, a tablet, and a smart textile.

11. The computer program product of claim 8, wherein the set of characteristics comprise: physical characteristics of an individual changed over time, social networks of the individual, friend networks of the individual, responses to events, family intellectual capital, physiological data obtained via wearable devices or smart textiles, financial history, medical history, and personal preferences of the individual changing over time.

12. The computer program product of claim 8, wherein the program instructions to provide a recommendation to one or more members of a family, further comprise at least one of:
program instructions to provide the recommendation using voice playback software in a simulated voice of an individual family member; and
program instructions to provide the recommendation using video playback software, which provides an image of the individual family member.

13. The computer program product of claim 8, wherein a set of characteristics from the plurality of genetic and hereditary data comprise individual preferences for each family member.

14. The computer program product of claim 8, wherein a recommendation comprises at least one of: precautions to be taken with diet based on hereditary predicative analysis; preventative tests based on personal data or lifestyle data; a set of preferences of an individual family member; medical direction associated with a medical history of a family member; dietary restrictions; travel recommendations based on location data; physical strengths; and physical weaknesses.

15. A computer system for making individualized recommendations, comprising:
one or more computer processors;
one or more computer readable storage media;
program instructions stored on the one or more computer readable storage media for execution by at least one of the one or more processors, the program instructions comprising:
program instructions to receive a plurality of genetic and hereditary data associated with a family origin;
program instructions to identify a set of characteristics associated with an individual, from the plurality of genetic and hereditary data, in a tree;
program instructions to, based on the set of characteristics associated with the individual, create an object pattern used to define a scoring model; and
program instructions to provide a recommendation to one or more members of a family, using an electronic device, wherein the recommendation is based on the individual and the object patterns associated with the set of characteristics.

16. The computer system of claim 15, further comprising:
program instructions to receive a plurality of reference data, wherein the plurality of reference data comprises geo-location data, time of day data, and weather data; and
program instructions to associate the plurality of reference data with the received plurality of genetic and hereditary data.

17. The computer system of claim 15, wherein the plurality of genetic and hereditary data associated with a family origin is collected from at least two different input modes, and wherein the input modes comprise at least one of: a mobile device, a wearable device, a computing device, a tablet, and a smart textile.

18. The computer system of claim 15, wherein the set of characteristics comprise: physical characteristics of an individual changed over time, social networks of the individual, friend networks of the individual, responses to events, family intellectual capital, physiological data obtained via wearable devices or smart textiles, financial history, medical history, and personal preferences of the individual changing over time.

19. The computer system of claim 15, wherein the program instructions to provide a recommendation to one or more members of a family, further comprise at least one of:
program instructions to provide the recommendation using voice playback software in a simulated voice of an individual family member; and
program instructions to provide the recommendation using video playback software, which provides an image of the individual family member.

20. The computer system of claim 15, wherein a set of characteristics from the plurality of genetic and hereditary data comprise individual preferences for each family member.
